(19) United States
(12) Patent Application Publication
(10) Pub. No.: US 2015/0186289 A1
(43) Pub. Date: Jul. 2, 2015

(54) CACHE ARCHITECTURE

(71) Applicant: Cambridge Silicon Radio Limited, Cambridge (GB)

(72) Inventor: Paul Hoayun, Willingham (GB)

(73) Assignee: Cambridge Silicon Radio Limited, Cambridge (GB)

(21) Appl. No.: 14/141,009

(22) Filed: Dec. 26, 2013

(51) Int. Cl. G06F 12/08

(52) U.S. Cl. CPC G06F 12/0893; G06F 2212/222

(57) ABSTRACT

A cache controller for a processing system, the cache controller being capable of providing an interface between a data requester and a plurality of memories including a first memory, a second memory and a cache memory, the cache controller being configured to, in response to receiving a request for data at a specified address in a specified memory, perform the steps of: determining whether either (a) a data field in the cache memory that corresponds to the specified address has been populated from the specified memory or (b) the specified memory is the first memory and the data field corresponding to the specified address in the cache memory has been populated from the second memory; and if that determination is positive, responding to the request by providing the content of the data field in the cache memory corresponding to the specified address.

This invention relates to cache architectures for data processing systems.

### BACKGROUND

It is known for a data processor to fetch data from multiple memories. Sometimes there can be a delay between the data processor requesting data from the memory and receiving that data. To mitigate that delay it is known to place a cache between the data processor and the memory. FIG. 1 shows such a system. The data processor 1 is connected via a data bus to a cache 2. The cache is connected to two memories 3 and 4. The memories 3 and 4 share an address space, so there is no overlap between the logical memory locations served by memory 3 and those served by memory 4. When the processor requires data from a location in memory 3 or 4 it makes a request to the cache, specifying the logical address of that location. If the cache holds the contents of that location it serves the data directly to the processor. If the cache does not hold the contents of that location it determines which memory the logical address is assigned to, obtains the contents of the corresponding physical location in the appropriate one of the memories 3, 4, serves that data to the processor and saves that data in the cache in case the processor requests it again. This avoids every request for data having to be served by one of the memories 3, 4. Memory locations in cache 2 can be tagged to indicate whether or not they have been populated.

A data processing device will typically include a microprocessor and an area of read only memory (ROM) which defines program code that is executable by the processor. The fact that ROM cannot be changed after manufacture can cause difficulties if errors are subsequently found in the code defined in the ROM. This can be dealt with by storing replacement code in another non-volatile memory. However, conventional techniques for effectively replacing the ROM's code with code from the other non-volatile memory can slow down the process of reading the program code. There is a need for an efficient way for a processor to read data from multiple memories.

### SUMMARY OF THE INVENTION

According to one aspect of the present invention there is provided a cache controller for a processing system, the cache controller being capable of providing an interface between a data requester and a plurality of memories including a first memory, a second memory and a cache memory, the cache controller being configured to, in response to receiving a request for data at a specified address in a specified memory, perform the steps of: determining whether either (a) a data field in the cache memory that corresponds to the specified address has been populated from the specified memory or (b) the specified memory is the first memory and the data field corresponding to the specified address in the cache memory has been populated from the second memory; and if that determination is positive, responding to the request by providing the content of the data field in the cache memory corresponding to the specified address.

The first memory may be a read only memory. The second memory may be a programmable non-volatile memory. The second memory may be a one-time-programmable memory. The second memory may be programmable by means of fusible links. The plurality of memories may include a third memory. The third memory may be a programmable memory. The third memory may be a non-volatile memory. Each of the plurality of memories may be of a different memory technology, for instance ROM, flash, OTP, or RAM.

The cache controller may be implemented on a first semiconductor substrate. The first memory and/or the second memory may be implemented on a second semiconductor substrate.

The cache controller may be configured to, if the said determination is negative, retrieve the content of the data field in the specified memory corresponding to the said address and respond to the request by providing the content of that data field.

The cache controller may be configured to, if the said determination is negative, retrieve the content of the data field in the specified memory corresponding to the said address, and determine whether the data field in the cache memory that corresponds to the specified address has been populated from the first or the second memories. If that latter determination is negative the cache controller may populate the data field in the cache memory that corresponds to the specified address with the retrieved content of the data field in the specified memory corresponding to the said address.

According to a second aspect of the present invention there is provided a cache controller for a processing system, the cache controller being capable of providing an interface between a data requester and a plurality of memories including a first memory, a second memory and a cache memory, the cache controller being configured to, in response to receiving a request to write data to a specified address in a specified memory, perform the steps of: if the specified memory is the first memory, storing the data at the specified address in the first memory; and if the data field in the cache memory that corresponds to the specified address has not been populated from the second memory, populating that data field with the data.

The first memory specified in the preceding paragraph may be a reprogrammable memory. The second memory specified in the preceding paragraph may be a programmable non-volatile memory. The second memory specified in the preceding paragraph may be a one-time-programmable memory. The plurality of memories may include a third memory. The cache controller may be configured to respond to at least some requests to read data from the third memory by providing data populated in the cache memory from the second memory.

According to a third aspect of the present invention there is provided a data processing system comprising: a cache controller having any one or more of the features as set out above, the data requester, the first memory, the second memory and the cache memory.

### BRIEF DESCRIPTION OF THE FIGURES

The present invention will now be described by way of example with reference to the accompanying drawings. In the drawings:

FIG. 1 shows a conventional cache architecture.

FIG. 2 shows another cache architecture.

FIG. 3 illustrates the structure of a cache memory.

FIG. 4 illustrates a read process.

FIG. 5 illustrates a write process.

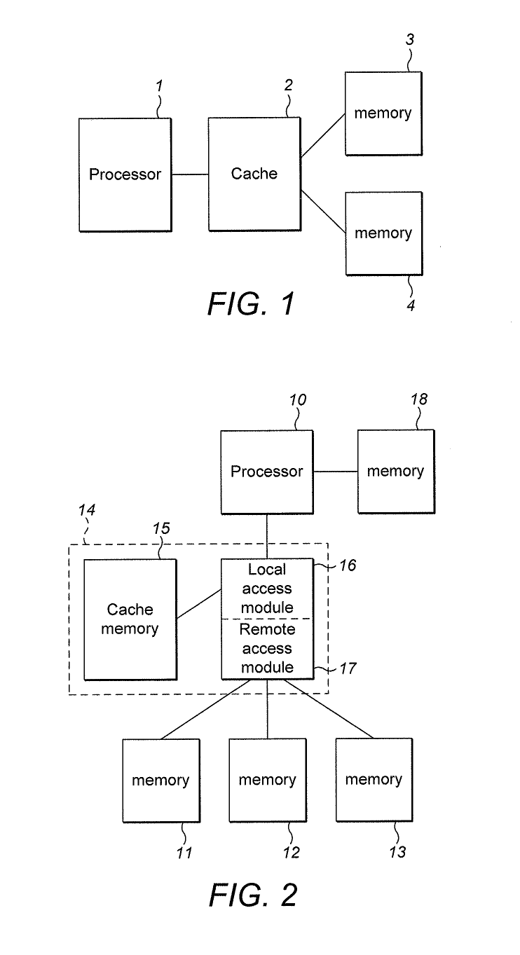

### DETAILED DESCRIPTION

FIG. 2 shows a cache architecture. In FIG. 2 processor 10 can retrieve data from any of memories 11, 12, 13 via cache 14. The cache comprises a random access memory (RAM) cache 15 and a cache controller 16, 17. The memories 11, 12, 13 do not share a common address space. As a consequence of that, when the processor requests data from one of the memories 11, 12, 13 via the cache controller it must do so specifying both a memory and a location in that memory. The cache controller is arranged to cache data from some or all of the memories 11, 12, 13 in RAM 15. It does so in such a way that data memory 11, which is a one-time programmable (OTP) memory can effectively overwrite data in memory 12, which is a ROM, with no additional load on the processor 10.

The processor 10 is a microprocessor that can execute program code to perform a variety of logical functions. It could be a general-purpose processor or it could have some dedicated function such as signal processing or audio processing. The microprocessor has access to a volatile random access memory (RAM) 18 which it uses as a temporary store.

Memory 11 is one-time programmable memory. It can be programmed with data only once. It is a non-volatile memory. Once programmed with data it will retain that data indefinitely with no usage of power. It could be programmed by means of an irreversible change to its hardware, for example by blowing one or more fusible links.

Memory 12 is a read only memory. It may store data from the time when it was manufactured. It is a non-volatile memory. It retains data indefinitely with no usage of power.

Memory 13 is a reprogrammable non-volatile memory, such as a flash memory. The processor can use memory 13 as a temporary store. The processor is capable of powering down working memory 18 when the processor is idle, in order to save power. As part of the power-down process the processor can store certain state in the non-volatile memory 13. When the processor wakes up it can reactivate the memory 18 and transfer the stored state data from memory 13 back to memory 18.

The cache controller 16, 17 acts as an intermediary between the processor 10 and the memories 11, 12, 13. One function of the cache controller is to handle data read requests from the processor 10 and serve them from the cache RAM 15 where possible. Another function of the cache controller is to handle data writes from the processor by storing data in the cache RAM 15 and, where appropriate, one of the memories 11, 12, 13.

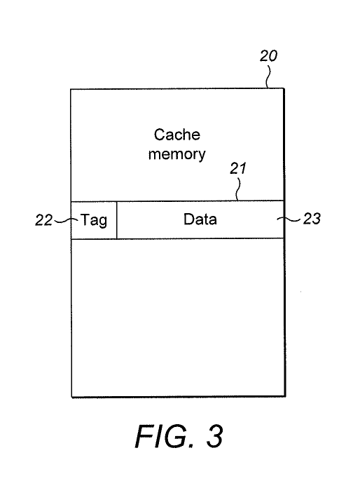

FIG. 3 illustrates the structure of the cache RAM 15. The memory comprises a memory space 20 which is considered to be formed of a series of data rows. One data row is shown at 21. Each data row has a respective memory location in the RAM 15. The address space of the RAM 15 is treated so it mirrors those of the memories 11, 12, 13. As a result, when the processor makes a data request from a certain address X in one of the memories 11, 12, 13 the location in the cache that corresponds to that address X is the location at the same address X in the memory space of the cache RAM 15.

Each data row 21 comprises a hardware tag 22 and a data block 23. Any row in the cache RAM 15 might hold data from any of the memories 11, 12, 13, or it might not have been populated. The hardware tag indicates which of those state the row is in. The hardware tag is two bits long. The significance of values of the hardware tag are as follows:

| Hardware tag state | Signifies |
|---|---|
| 00 | Row populated from memory 11 |
| 01 | Row populated from memory 12 |
| 10 | Row populated from memory 13 |
| 11 | Row not populated/invalid |

The hardware tag could have more bits, for example if the cache were serving more than three memories.

The cache controller comprises a local access module 16 and a remote access module 17. The local access module interfaces with cache RAM 15. The remote access module interfaces with memories 11, 12, 13.

The operation of the cache controller will now be described.

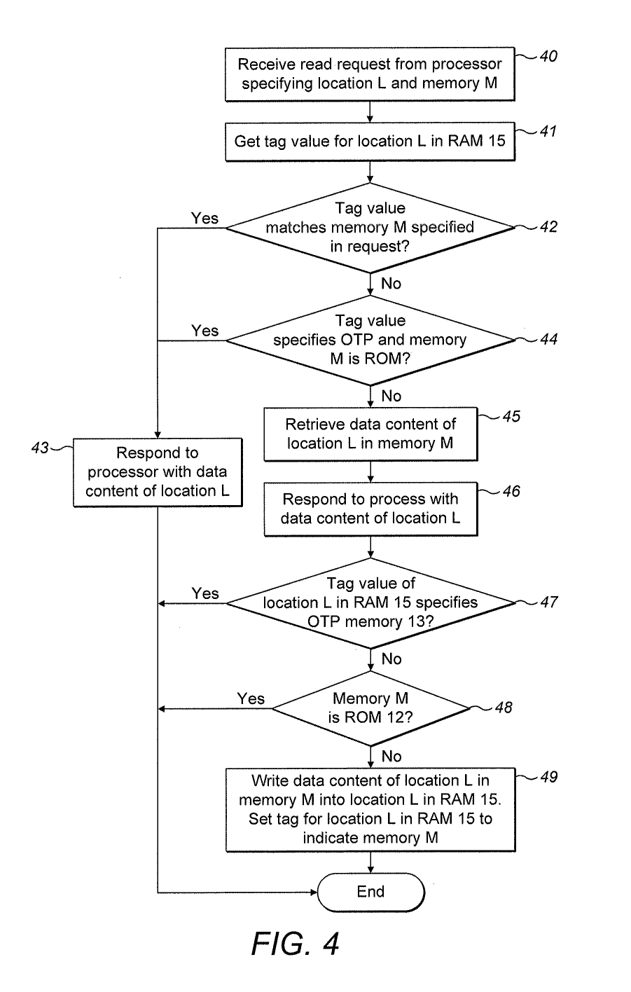

FIG. 4 illustrates the steps involved in a read operation. When the processor 10 makes a data read request that request is transmitted to the local access module 16. (Step 40). The request specifies the location from which data is to be read by indicating both (a) one of the memories 11, 12, 13 (memory “M”) and (b) an address (location “L”) in that memory from which the data is to be read. The local access module determines whether that location in that memory is cached in RAM 15. To do this it retrieves the hardware tag value (field 22) stored at location L in RAM 15 (step 41), and checks whether its value matches, according to the table above, the memory M specified in the read request (step 42). If there is a match, that indicates the relevant data is cached in RAM 15, and the local access module responds to the request from the processor with the data content (field 23) stored at location L in RAM 15. (Step 43). If there is no match, the local access module checks whether both (a) the hardware tag signifies the OTP memory 11 and (b) the memory M specified in the read request is ROM 12 (step 44); and if both of those criteria are satisfied then the local access module responds to the request from the processor with the data content (field 23) stored at location L in RAM 15 (step 43). The purpose of this check will described below. Otherwise, the local access module signals the remote access module with a read request for memory M and address location L. This causes the remote access module to read the data stored at that location in that one of the memories 11, 12, 13. (Step 45). The remote access module returns that data to the local access module. Then the local access module responds to the request from the processor with the data content retrieved from location L of memory M. (Step 46). The local access module may also update the cache so that if the processor requests data from location L of memory M in future, that request can be served from cache RAM 15 instead of from memory M. For some types of memory 11, 12, 13 that may save time in responding to future read requests from the processor. The local access module checks whether the tag value it read at step 41 specifies the OTP memory 13 (step 47) and if the memory M from which the data was retrieved is ROM 12 (step 48). The reasons for these checks will be described below. If the answers to both these checks are negative then the local access module writes the data retrieved from memory M into location L in the cache RAM 15 and sets the hardware tag value for that location in the cache RAM to signify memory M according to the table above. (Step 49). This means that the newly written data can be matched in step 42 of a subsequent read operation.

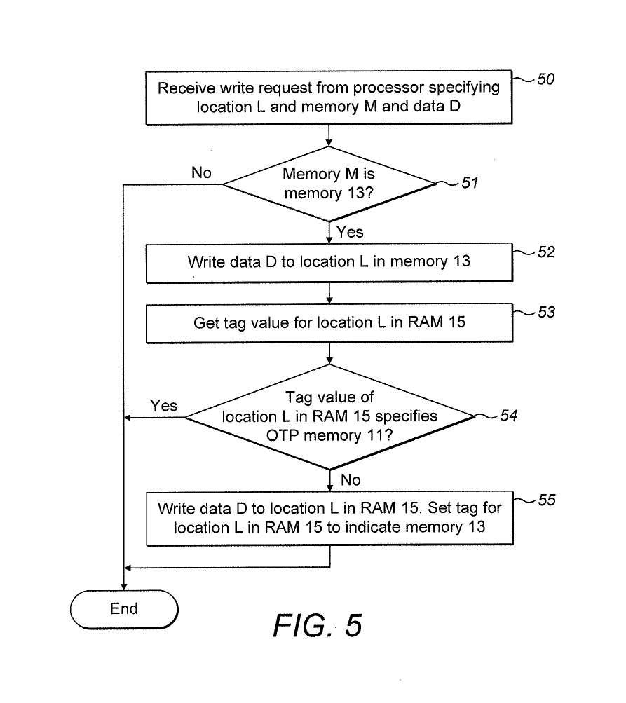

FIG. 5 illustrates the steps involved in a write operation. When the processor 10 makes a data write request that request is transmitted to the local access module 16.

(Step 50). The request specifies the data to be written (“D”) and the location to which the data is to be written by indicating both (a) one of the memories 11, 12, 13 (“M”) and (b) an address (“L”) in that memory to which the data is to be written. The local access module determines whether memory M specifies memory 11. (Step 51). It does that because in this example only memory 11 is writable. If the answer is yes then it writes the specified data D to location L in memory 11. (Step 52). It may update the cache so that if the processor requests data from location L of memory 11 in future, that request can be served from cache RAM 15. The local access module retrieves the hardware tag value at location L in cache RAM 15 (step 53) and checks whether that tag specifies the OTP memory 13. (Step 54). The reason for this check will be described below. If not, it writes the specified data D into location L in the cache RAM 15 and sets the hardware tag value for that location in the cache RAM to signify memory 11 according to the table above. (Step 55).

The ROM 12 cannot be changed after manufacture. With normal manufacturing techniques, in which the ROM is defined through masks and other semiconductor fabrication processes, once one design has been committed for manufacture it is expensive to make updates to the manufacturing process to change the ROM for future products. This means that it is difficult to change the ROM for future products even if errors are found in the program code it defines, or if enhancements are made to that code. One function of OTP memory 11 is to accommodate such changes. The OTP memory can be programmed after the system has been fabricated. The OTP memory 11 could be embodied on a semiconductor substrate. The process of fabricating the substrate defines the components that make up the OTP memory 11 but not their data content. Once the substrate has been fabricated, the content of the OTP memory can be written as a subsequent stage of the manufacturing process. For example, after fabrication the integrated circuit could be packaged in a protective, electrically insulating package. The OTP memory could be written after packaging. The cache controller allows content in the OTP to supersede, and effectively to overwrite, certain values in ROM 12. This works in the following way.

When the cache 14 is initiated the cache controller reads from OTP memory 11 any data that is to supersede corresponding data in ROM 12. Each element of such data in OTP memory 11 is intended to supersede the data at a certain location in ROM 12. The cache controller writes each element of such data to the data field 23 of the location in cache RAM 15 that matches the location in ROM 12 that the data is to supersede, and sets the hardware tag 22 for that location in cache RAM 15 to indicate the OTP memory 11. For example if the OTP memory contains data D that is to supersede the data at location L in the ROM 12, the cache controller writes data D to the data field at location L in cache memory 15. To achieve this, the cache controller could simply read the whole of OTP memory 11 and copy any value in the OTP memory that is not a reserved value (e.g. all zeros) into the same location in cache RAM 15 as it was read from in OTP memory 11 and set that location's hardware tag to “00”. Alternatively, the OTP memory could hold a directory that indicates to the cache controller which data in the OTP memory is to be copied to which locations in the cache RAM.

Returning to FIG. 4, it can be seen that once the cache RAM has been loaded with the relevant data from OTP memory 11, the effect of step 44 is to cause the data from the OTP memory 11 that has been stored in the cache RAM to be served to the processor in response to a request from the processor for the data at the corresponding location in ROM 12. It can also be seen that the effect of steps 47 and (in FIG. 5) 54 is to avoid data from the OTP memory 11 that has been stored in the cache RAM being overwritten by caching data read from flash memory 13. A consequence of steps 47 and 54 is that the cache is unable to cache all locations in the flash memory 13, so any speed increases from caching flash memory 13 cannot be had for all locations in the flash memory. This consequence is mitigated by the fact that the cache can automatically both (a) serve as a source for data from the processor from all of memories 11, 12 and 13 and (b) in effect overwrite parts of the RAM with data from the OTP.

The memories 11, 12 and 13 could take other forms. For example, memory 11 could be a flash memory. Memory 11 could be in an external and/or removable memory module that can be coupled to the processor, cache controller and ROM after they have been manufactured and/or embodied in an end-user device. Memory 12 could be re-writable, but perhaps at a large cost. Memory 13 could be a volatile re-writable memory such as DRAM or SRAM.

Step 48 could be omitted. The effect of that would be to cache data from ROM 12 in addition to data from memories 11 and 13. However, if memory 12 is a hardware ROM it may be expected that reading from it is fast, and so the speed increase from caching its data in cache RAM 15 may be negligible. Step 48 allows more data from memory 13 to be cached, since it will not be overwritten by data from ROM 12.

In one convenient implementation, processor 10 and cache 12 are formed on a single integrated circuit substrate. ROM 12 may be on the same semiconductor substrate. Alternatively ROM 12 may be on a different semiconductor substrate. OTP memory 11 may be on the same semiconductor substrate. Alternatively OTP memory 11 may be on a different semiconductor substrate. OTP memory 11 and ROM memory 12 could be on the same semiconductor substrate as each other.

In the example given above there is a one-to-one mapping between addresses in cache RAM 15 and each of memories 11, 12 and 13. Alternative arrangements are possible. The cache controller could be configured to map an address range in cache RAM 15 onto a different address range in one of memories 11, 12 and 13 to the range onto which it is mapped in one or both of the others. This technique could be used to mitigate the effects of the cache controller giving priority to caching data from the OTP memory 11 where this would be overwritten by data from the flash memory 13. The cache controller could be arranged so that it maps an address range in cache RAM 15 onto a range of one of memories 11 and 13 that is expected to be frequently used and onto a range of the other of those memories that is expected to be infrequently used.

The cache RAM 15 could be used for purposes additional to caching. For example it could also act as working RAM 18 for processor 10.

The memories 11, 12, 13 and 15 could be of different sizes from each other. If the cache RAM 15 is smaller than one of the other memories then it cannot store data from the larger memory at a location that has the same address in memory 15 as in that larger memory. The cache controller could implement a mapping from addresses in any of the memories 11, 12, 13 to different addresses in cache RAM 15.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A cache controller for a processing system, the cache controller being capable of providing an interface between a data requester and a plurality of memories including a first memory, a second memory and a cache memory, the cache controller being configured to, in response to receiving a request for data at a specified address in a specified memory, perform the steps of:
determining whether either (a) a data field in the cache memory that corresponds to the specified address has been populated from the specified memory or (b) the specified memory is the first memory and the data field corresponding to the specified address in the cache memory has been populated from the second memory; and
if that determination is positive, responding to the request by providing the content of the data field in the cache memory corresponding to the specified address.

2. A cache controller as claimed in claim 1, wherein the first memory is a read only memory.

3. A cache controller as claimed in claim 1, wherein the second memory is a programmable non-volatile memory.

4. A cache controller as claimed in claim 1, wherein the second memory is a one-time-programmable memory.

5. A cache controller as claimed in claim 1, wherein the plurality of memories includes a third memory.

6. A cache controller as claimed in claim 1, wherein each of the plurality of memories is of a different memory technology.

7. A cache controller as claimed in claim 1, wherein the cache controller is implemented on a first semiconductor substrate and at least one of the first and second memories is implemented on a second semiconductor substrate.

8. A cache controller as claimed in claim 1, wherein the cache controller is configured to, if the said determination is negative, retrieve the content of the data field in the specified memory corresponding to the said address and respond to the request by providing the content of that data field.

9. A cache controller as claimed in claim 1, wherein the cache controller is configured to, if the said determination is negative, retrieve the content of the data field in the specified memory corresponding to the said address, determine whether the data field in the cache memory that corresponds to the specified address has been populated from the first or the second memories, and if that latter determination is negative populate the data field in the cache memory that corresponds to the specified address with the retrieved content of the data field in the specified memory corresponding to the said address.

10. A data processing system comprising: a cache controller as claimed in claim 1, the data requester, the first memory, the second memory and the cache memory.

11. A cache controller for a processing system, the cache controller being capable of providing an interface between a data requester and a plurality of memories including a first memory, a second memory and a cache memory, the cache controller being configured to, in response to receiving a request to write data to a specified address in a specified memory, perform the steps of:
if the specified memory is the first memory, storing the data at the specified address in the first memory; and
if the data field in the cache memory that corresponds to the specified address has not been populated from the second memory, populating that data field with the data.

12. A cache controller as claimed in claim 11, wherein the first memory is a reprogrammable memory.

13. A cache controller as claimed in claim 12, wherein the second memory is a programmable non-volatile memory.

14. A cache controller as claimed in claim 12, wherein the second memory is a one-time-programmable memory.

15. A cache controller as claimed in claim 12, wherein the plurality of memories includes a third memory and the cache controller is configured to respond to at least some requests to read data from the third memory by providing data populated in the cache memory from the second memory.

16. A data processing system comprising: a cache controller as claimed in claim 12, the data requester, the first memory, the second memory and the cache memory.
